(19) United States
(12) Patent Application Publication
(10) Pub. No.: US 2007/0235533 A1
(43) Pub. Date: Oct. 11, 2007

(54) System and/or method for self-serve purchases

(75) Inventor: Joseph A. Giordano, Centreville, VA (US)

Correspondence Address: NIXON & VANDERHYE, PC, 901 NORTH GLEBE ROAD, 11TH FLOOR, ARLINGTON, VA, 22203, US

(73) Assignee: Advanced Payment Products, LLC, Centreville, VA (US)

(21) Appl. No.: 11/783,184

(22) Filed: Apr. 6, 2007

Related U.S. Application Data
(60) Provisional application No. 60/744,498, filed on Apr. 8, 2006.

(51) Int. Cl. G06K 15/00; G06F 7/08

(52) U.S. Cl. 235/383; 235/381

(57) ABSTRACT

The exemplary embodiments described herein relate to techniques for processing self-serve transactions. A store controller may be capable of communication with a payment network. At least one self-serve device may allow the customer to order an item via the device. The at least one self-serve device may comprise customer recognizing programmed logic circuitry to recognize the customer, authorizing programmed logic circuitry to authorize, via the payment network, transactions on behalf of the customer after the customer is recognized, and delivering programmed logic circuitry to cause an ordered item to be delivered to the customer after the customer is recognized by the customer recognizing programmed logic circuitry and after the authorizing programmed logic circuitry authorizes transactions for the customer. An application controller may be capable of mediating between the store controller and the at least one self-serve device.

### CROSS-REFERENCE TO RELATED APPLICATION

This application claims the benefit of U.S. Application Ser. No. 60/744,498, filed on Apr. 8, 2006, the entire contents of which is incorporated herein by reference.

### FIELD OF THE INVENTION

The exemplary embodiments described herein relate to systems and/or methods for handling and/or processing self-serve purchases. In particular, certain exemplary embodiments relate to systems and/or methods for handling and/or processing self-serve purchases in which at least some of a customer's transactions within a store are preauthorized, aggregated, and/or completed substantially without interaction with a store employee.

### BACKGROUND AND SUMMARY

Speed and ease of retail transactions create opportunities to simplify day-to-day activities. Today, given the complexity of lifestyles, time is a more important asset than ever before. Speed, ease, and the general convenience throughout the day-to-day routine have become critical deliverables for any product that seeks to simplify the lives of today's consumer. Reducing and/or eliminating even the simplest steps to ease operation of mundane tasks can create a large perceived value and sense of speed for the consumer. Of course, any process that makes mundane tasks faster and easier leaves more time for more important activities, leisure, etc.

Unfortunately, conventional retail checkout still is a choke point and a slow down in the retail buying process. Retailers generally have moved to a “self-serve” payment process where consumer's swipe their own cards and push buttons on the payment terminal to pay for goods and services. This self-serve payment process has been accepted by the consumer because it puts the purchaser in control and reduces the need to wait for slow and unresponsive clerks.

Although such techniques have improved traditional retail transactions, the process of payment at the point of sale still can be simplified yet further. For example, one inconvenience relates to having to wait in line to “check-out,” which remains a problem and complication that consumers encounter. Another example relates to the time it takes to wait for the clerk to “scan” the products being purchased. In total, there are major opportunities to simplify consumers' lives by making the buying experience simpler through the implementation of faster, easier processes related to reducing check-out queues, “scanning” goods to be purchased, and payment.

In addition to the convenience-related concerns of consumers, the cost of qualified labor also impacts the retail industry. For example, retailers struggle more and more every year to fill positions in their stores with qualified labor at acceptable price points. As a result, the industry struggles to provide adequate service. Turnover tends to be high and has been known to reach 100% in some instances. Training is difficult and sometimes almost impossible to implement consistently with such high levels of turnover. As a result, retailers do not have much capability to increase capacity at check out by hiring more people.

The number of pay-points in a convenience setting is also a concern. In a convenience-oriented retail business, premium locations are critical to success. As such, the cost of real estate is a major concern for any convenience-oriented business. As a result, property sizes tend to be smaller making space a premium. Given this lack of space in convenience-oriented businesses, it is difficult to add additional pay-points within the store. In addition to space constraints, there typically are costs to adding another pay-point including building changes, furniture, equipment costs, and wiring and installation expenses. These costs typically are not insignificant. Both space constraints and infrastructure costs create significant obstacles to adding additional pay-points in a convenience retail setting.

Control of the self-service environment is still another concern in the retail industry. The trend toward self-service is well underway at retail locations with wide-scale implementation of payment applications. But the increased use of vending machines, e.g., for purchases such as beverages (such as, for example, fountain drinks and coffee), creates control-of-product concerns that have stopped wide-scale implementation of self check-out including both scanning of items and payment. Indeed, an obstacle remains relating to how to enable the process for consumers, yet reduce (or prevent) wide-scale looting of product from the store. Grocery stores and home improvement centers have implemented self-checkout processes, but they tend to be cumbersome and slow. Most consumes still opt to stand in line and wait for a clerk. Additionally, most of these processes require a dedicated person to oversee the activities to insure that there is no abuse of the system and to help with its cumbersome operation.

Credit and debit card fixed transaction fees in a small ticket environment are also a concern in the retail industry. This concern is yet another challenge of the self-serve shopping experience in a convenience setting where a financial obstacle is created by the combination of small transaction amounts with “fixed fees,” and the resulting impact on retailer margins. Credit and debit card companies typically charge fees with both a fixed and a variable component. While retailer margins do not change with a variable fee (except when they are increased), retailer margin is affected by a reduction in transaction sizes. In other words, if there is a fixed fee of $0.10 per transaction, the business is much better off with transaction sizes of five $10 transactions, than ten $5 transactions. This is a challenge for any self-serve process that encourages the use of electronic payments and either increases the number of small transactions, or converts large transactions into several smaller ones.

Thus, it will be appreciated that there is a need in the art for improved systems and methods for handling and/or processing self-serve purchases.

Certain exemplary embodiments described herein may be used separately or in various combinations. Thus, certain exemplary embodiments may have one or more of the following illustrative aspects.

One aspect of certain exemplary embodiments relates to a system for self-service purchasing comprising an integrated identification reader with a stand alone empty cup dispenser.

Another aspect of certain exemplary embodiments relates to a self-service process for dispensing bulk beverages, with the process comprising maintaining simultaneous purchasing and dispensing control, and paying upon receipt of each empty beverage container. Optionally, the self-service process may be authorized each time an item is chosen from a retail location, and all item prices may be aggregated and treated as one payment transaction.

Still another aspect of certain exemplary embodiments relates to a self-service process, with the process comprising utilizing a reader for each type of product selected by a customer, and reducing (e.g., eliminating) any manual scanning of product or product identifier by the customer or any sales clerk, wherein the identification of the customer and the selection of each product by the customer are simultaneous.

Yet another aspect of certain exemplary embodiments relates to a self-service process, with the process comprising utilizing a reader to authenticate and enable electronic payment by the customer, and reducing (e.g., eliminating) any manual scanning of product or product identifier by the customer or any sale clerk, wherein the detection of the item selected is determined automatically by the cup dispenser.

A further aspect of certain exemplary embodiments relates to a self-service process, with the process comprising using pre-authorization to allow removal of goods from a store and subsequently completing the sales transaction for the goods.

Still a further aspect of certain exemplary embodiments relates to a method of using RFID for self-service beverage orders in a manner that reduces (e.g., does not require any) change to beverage dispensing equipment, wherein the RFID is integrated or linked to an empty cup dispenser, and wherein multiple ID readers are enabled for a single virtual terminal without replacing any beverage equipment.

In certain exemplary embodiments, a wireless technology may be used to connect multiple readers together as one virtual payment terminal through an application controller. Also, in certain exemplary embodiments, a self-service terminal may be connected to a real-time payment system. Optionally, the self-service system may integrate RFID, smartcard, infrared, barcode, biometric, and/or magnetic strip identification technologies.

According to certain exemplary embodiments, a system for processing self-serve transactions of a customer is provided. A store controller may be capable of communication with a payment network. At least one self-serve device may allow the customer to order an item via the device. The at least one self-serve device may comprise customer recognizing programmed logic circuitry to recognize the customer, authorizing programmed logic circuitry to authorize, via the payment network, transactions on behalf of the customer after the customer is recognized, and delivering programmed logic circuitry to cause an ordered item to be delivered to the customer after the customer is recognized by the customer recognizing programmed logic circuitry and after the authorizing programmed logic circuitry authorizes transactions for the customer. An application controller may be capable of mediating between the store controller and the at least one self-serve device.

According to certain other exemplary embodiments, a method of processing self-serve transactions of a customer made using at least one self-serve device is provided. The customer may be recognized via a reader. Via a payment network, transactions may be authorized on behalf of the customer after the customer is recognized. An item ordered by the customer may be ordered after the customer is recognized and after transactions are authorized for the customer. A store controller may be capable of mediating between communication with an outside payment network and the at least one self-serve device via an application controller.

According to yet other exemplary embodiments, a self-serve device for allowing a customer to order an item via the device is provided. Customer recognizing programmed logic circuitry may be provided to recognize the customer. Authorizing programmed logic circuitry may be provided to authorize, via store controller in communication with a payment network, transactions on behalf of the customer after the customer is recognized. Delivering programmed logic circuitry may be provided to cause an ordered item to be delivered to the customer after the customer is recognized by the customer recognizing programmed logic circuitry and after the authorizing programmed logic circuitry authorizes transactions for the customer.

### BRIEF DESCRIPTION OF THE DRAWINGS

These and other features and advantages will be better and more completely understood by reference to the following detailed description of exemplary illustrative embodiments in conjunction with the drawings, of which:

FIG. 1 is an illustrative process that a hypothetical customer might choose to follow in using a self-serve purchase system in accordance with an exemplary embodiment;

FIG. 2 is a flowchart demonstrating an illustrative process for using a self-serve purchase system in accordance with an exemplary embodiment;

FIG. 3 is a simplified illustrative store layout including a self-serve purchase system in accordance with an exemplary embodiment;

FIG. 4 is a simplified flowchart demonstrating an illustrative process using a self-serve purchase system in accordance with an exemplary embodiment; and,

FIG. 5 is an illustrative self-serve device in accordance with an exemplary embodiment.

### DETAILED DESCRIPTION

The exemplary embodiments described herein relate to systems and/or methods for handling and/or processing self-serve purchases. As will be appreciated from the following description, the techniques described herein may be used in alone and/or in various combinations.

1. Introduction

The capacity of most convenience-oriented retail stores is constrained during peak times by the size of their format and the number of pay-points. This problem is exacerbated for consumers as convenience is becoming increasing important. As a result, there is an opportunity to increase the capacity of the store, and dramatically improve the convenience value for consumers by, for example, implementing a self-service check-out and payment process that is simple, easy, and secure for the purchaser, and secure and simple to manage for the retail operator. Certain exemplary embodiments help solve queuing, check-out, and payment related complexities for consumers while also simplifying operations without creating control issues for operators.

1.1 Ordering and Pre-Authorizing Bulk Beverages

The purchase of coffee and fountain drinks conventionally requires waiting in a queue to pay despite being able to fill the drink without a clerk. Currently, it is not practical to pay for a drink as it is dispensed because the cost of such an implementation would far exceed its benefit, and it is difficult to pre-determine the precise amount of beverage to pour into a cup due to differences in the amount of ice, spills, and other operational problems. Additionally, many beverages are in containers, such as coffee pots, which can not be easily automated. Therefore, one solution employed by certain exemplary embodiments is to approve the transaction when the cup is dispensed rather than when the beverage is dispensed. In other words, upon presenting a payment id token, an automated cup dispenser would dispense one cup that could be filled with the appropriate beverage. In the case of a convenience retail format such as a convenience store, fast food restaurant, or coffee shop, the customer would enter the store and wave, present, or swipe an RFID enabled device (e.g., key ring token, card, cell phone, MP-3 player, PDA, any commonly carried device with an RFID chip), magnetic strip card, bar code device or card, or infra-red ID token to the ID reader integrated within the cup dispenser. The cup dispenser contains mechanical technology to automatically dispense a cup, or allow a customer to remove a cup from a sleeve, when the system command is given to do so and a payment ID reader which could be configured to read any of the technologies mentioned above (or similar ID technologies). The customer would simply present their ID, the reader in the cup dispenser would transmit the identification information (supplied in standard Visa/MC format) to the Application Controller.

1.2 Aggregating Orders and Finalizing the Self-Serve Transaction

An exemplary system may check to determine if there has been a transaction from the id within a predetermined time period (e.g., the last 15 minutes, 30 minutes, etc.). If not, the transaction is passed to the store controller for authorization just as would happen from a payment terminal. The store system would process the authorization just as it normally would and then return the response to the store controller and then back to the Application Controller, which would send the command to the cup dispenser to dispense the cup. This approval process may be accomplished very quickly (e.g., within about three-to-five seconds) and the customer would receive a message on a display that indicates waiting for authorization until the approval is received, at which time the screen would indicate approval and the cup would be automatically dispensed. The customer then could fill the cup with the desired beverage and leave the store. If the transaction is rejected, the appropriate message would be displayed, and the cup would not be dispensed. In certain exemplary embodiments, if this were the second transaction within the allotted time period, a duplicate authorization may not required, and the cup may be dispensed instantly.

Alternatively, a retailer may decide to instantly dispense the cup thus bypassing the authorization process and sending a message to the cashier upon rejection of a transaction so that the cashier or other store personnel can intervene. This alternative approach may be more risky, also but may be worthwhile to create the perception of instant response.

Purchasers may present their payment id as many times as they like for multiple cups of coffee, fountain drinks, and other vended items. Upon completion of filling all the cups desired and collecting all other vended goods, the customer can simply leave the store. The system may check at predetermined time intervals (which may be configurably programmed to, for example, every few seconds) for authorizations that have not been finalized since some configurable time period (e.g., within 20 minutes) since the last purchase order. When the system notices that there have been no orders within that time period, the system will aggregate all ordered goods, associate them with the initial authorization and id number, and transmit the total amount to the store controller to be forwarded to the payment networks to finalize the transaction. This procedure may reduce the number of small amounts charged. That is, it may be possible to reduce the chances or avoid having a separate charge for each item ordered, and instead have one amount for the entire transaction as is more typical of purchases at a store. Additionally, it reduces the need for retailers to have to pay fixed fees on many small transactions.

Alternatively or in addition, there may be a wireless receipt printer and reader next to the door and the customer could present their payment id at the printer reader on the way out the door to get a receipt. In this case, the system may print a receipt of all orders since the initial authorization and process the transaction in the same manner as the automatic mode where each individual order would be aggregated to a single transaction. In this scenario, the trigger would be the request for a receipt rather than an elapsed time period since the last order.

Additionally, the process may include other manual control mechanisms, such as, for example, printing a date stamp on the cups as they are dispensed so that at any time a store employee can spot check the cup to make sure that it is not one that was dispensed from a previous day. Another approach to this might be the use of a different color cup for each day. This would at least enable the detection of the use of the same cup in successive days, or nearly successive days.

1.3 Ordering and Pre-Authorizing Vending and Kiosk Items

Other vending items can be purchased with the same process by integrating payment id readers within the vending machine, and integrating the vending machines within this self-serve payment system. There would no difference in the payment process. The vending machine simply would replace a read at a cup dispenser. For example, the purchaser could present their payment id at the cup dispenser, obtain a cup, pour a cup of coffee, present id at the snack machine and get a candy bar, and then present payment id at the receipt printer to get a receipt and finalize their transaction.

2. Exemplary Techniques for Self-Service Purchases

Certain exemplary embodiments enable customers to order and purchase self-service items without stopping at the checkout counter. These features may be accomplished while maintaining both control from an operational point of view, and convenience and security from a consumer point of view.

2.1 Exemplary Customer Process

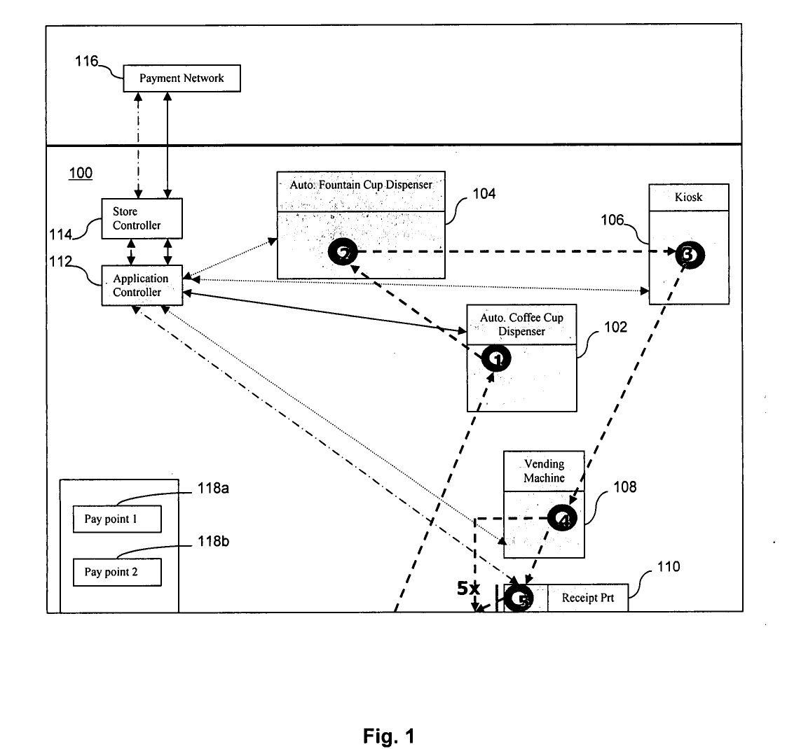

Referring now more particularly to the drawings, FIG. 1 is an illustrative process that a hypothetical customer might choose to follow in using a self-serve purchase system in accordance with an exemplary embodiment. In this example, the customer moves to position number 1 and presents their ID to the reader at the automatic cup dispenser. The reader is attached to the automatic cup dispenser such that when it is presented, the customer is approved for purchase real-time, and a cup is dispensed. The cup dispenser may be one of a variety of automatic cup dispensers that today are contained within various commercial coffee and beverage dispensing equipment. However, the cup dispenser need not be integrated with the beverage dispensing equipment, but instead may be separated as a stand alone device and is integrated with the payment identification reader within this unique payment system. Once the customer is approved and receives a cup, coffee or other any other beverage can be dispensed as they are today.

Because it would be difficult to control the flow of bulk beverages either from a coffee pot, fountain machine, or other bulk dispensing process, one feature of certain exemplary embodiments relates to tying the authentication, order, and/or payment to dispensing the cup rather than the beverage. As such, the payment identification reader could be integrated with the cup dispensing equipment or connected by a cable. The customer would simply present a contract-less RFID payment card or token, or swipe a traditional magnetic strip card, etc. The first read would require a “pre-authorization” described below to ensure that the customer was authorized for a credit or debit transaction. After being read, the reader would provide feedback to the customer in the form of any or all of: words or graphics on a screen, an audible sound, a light, etc. The response could be provided instantly with a local authentication of the device, but prior to waiting for the payment network to authorize. Retailers may choose to wait until after payment network authorization to dispense a cup, as the delay is likely to be short. This short delay may occur only on the first purchase for a given customer visit (e.g., other transactions may not require further authorizations). This slight delay has generally been accepted by consumers through fuel dispensing systems.

In a scenario where retailers choose to dispense a cup prior to payment network approval, the system may be configured to notify the clerk of a rejected transaction, and the clerk may have to notify the customer to stop at the checkout counter prior to leaving the store. In either case, after the cup is dispensed, the customer may pour the beverage of choice and then proceed to other purchase and order points to purchase other beverages, and other vended items. After the customer has made all the purchases that they would like, they may simply leave the store. If the customer would like to get a receipt, the customer simply may present or swipe their ID at a reader associated with a receipt printer. The receipt printer may print all items that were purchased on the visit to the store. In using this process the customer can quickly enter the store, and collect and pay for items. The customer may leave the store without ever waiting in line or relying on store personnel.

2.2 Exemplary Data Flow

From the point that the customer presents or swipes their ID, the reader may immediately process the token to insure that it is authentic. These processes are a function of the chosen security approach by the technology vendor. Commonly used technologies include, for example, RFID and magnetic stripe, but also may include infrared, biometric, or other potential identification technologies. Additionally, custom store- or chain-based cards or devices may be used. After checking to make sure that the device is authentic (e.g., based on a security algorithm used), the ID number may be forwarded to the Application Controller. The Application Controller may determine whether this is the first read for the customer's visit to the store. The controller may specifically search for any “Un-finalized” purchases. Un-finalized purchases are those where the customer has presented an ID for initial authorization, but the system has not yet sent a final authorization. If there are no Un-finalized purchases, it is the First Read. The First Read requires an Initial Authorization with the payment method and bank associated with the ID. The Application Controller will send the request for authorization to the site controller. If it is not the First Read (previously approved, but Un-finalized purchases already exist for a particular customer), the newly requested purchase is approved and sent back to the reader with the appropriate message code.

For First Reads, the site controller may process the transaction in a similar manner to credit and debit card transactions today. The site controller may determine the type of transaction and format the transaction pursuant to specifications of the host processor and forward the transaction to the host processor via the communications network (e.g., via satellite, dialup, DSL, frame relay, cable, etc.). The host control system may process the transaction with the appropriate payment network and bank as it does today securing either an approval or rejection for the transaction. The appropriate message code will be returned to the site controller. The site controller will forward the response to the Application Controller.

The Application Controller then may track and/or interpret the response (e.g., approval or rejection) and send back to the reader. The reader will display the appropriate response via the screen, light, audible tone, or other communication mechanism. If the transaction is approved, the customer will receive a cup (in the case of bulk coffee or other beverage), the vended item selected (e.g., cigarettes, snacks, etc.), a ticket in the case of a kiosk order (e.g., subs, pizza, etc.), etc. At this point, the customer can collect the purchased goods and either leave the store or present the ID again to purchase another item.

When leaving the store, the customer can elect to get a receipt or just leave. If the customer wants a receipt, the customer can present the ID at a standalone receipt printer (most likely positioned near the door). When the customer presents the ID to the reader connected to the receipt printer, the ID is authenticated, and forwarded to the Application Controller. All items purchased since the First Read are matched with the initial authorization and aggregated as one transaction and totaled. The receipt is printed immediately. The customer can take their receipt and leave. Concurrent with the receipt being printed, the transaction is forwarded to the site controller where it is formatted and sent to the payment network (as detailed above) for final authorization. Upon receipt of final authorization from the payment network, the site controller forwards the response with the appropriate message code back to the Application Controller. The Application Controller then closes out the transaction.

Alternatively, in the case where the customer simply leaves the store, the system is configured by the retailer for a customer defined time period to automatically finalize any open transactions based on the time from the First Read (e.g., 30 minutes). After this designated time period from the initial read, the transaction is aggregated, totaled, and forwarded to the site controller for finalization of the transaction. The site controller may proceed in the same manner as it would if a receipt were requested formatting and sending the transaction to the payment network for final authorization. Upon notification from the site controller, the Application Controller closes out the transaction.

As a result of this process, customers simply may walk in, present their IDs, collect their items, and walk out or, if they want a receipt, present their ID once more to obtain a receipt. Operationally, the store need not necessarily monitor purchases to ensure that all goods are scanned properly because payment is made in advance. The store may use differently colored cups so that they are easily identified as a “self-service” transaction when customers exit the store. Similarly, packaging from other vended items may be uniquely marked, or may only be sold exclusively through the self-service channel to ensure no confusion regarding whether customers had paid for an item or not.

2.3 Devices and Related Processes

The automatic cup dispenser may be integrated with a multi-function identification reader. The cup dispenser itself can be developed using different approaches. For example, the cup dispenser may include one or more of the following features:
Automatically Dispensed—It can integrate the same or similar technology to what has been implemented within automatic coffee or beverage machines that automatically dispense cups.
Manually pulled after automatically enabled—A mechanical device can be added to a traditional cup sleeve. The mechanical device added to a cup sleeve dispensing unit would help to prevent a customer from pulling or otherwise getting a cup until the system gave an enabling command.
One reader per cup type and size—The cup dispenser could be implemented in a manner where there is one reader for each size cup and type. In this scenario, a customer presenting an ID would both seek authorization for the purchase and selecting a particular cup size and type.
One reader for many cup sizes and types with automatic detection—The cup dispenser may have one ID reader for all cup sizes and types to be dispensed. In this approach, the cup dispenser would enable pulling any cup when the system command is given, and further could automatically detect the size and type of cup that was taken. This may be accomplished, for example, through the use of an infrared beam, by measuring the change in weight of each stack of cups, or through the use of a mechanical counting mechanism.
One reader for many cup sizes with button cup designator—The cup dispenser would enable a cup to be taken when the system command is given, and would further use a button pressed by the customer to designate which cup was taken to enable either automatic or manual dispensing of the cup.

The cup dispenser may be integrated with a reader that would have the capability of reading one or multiple technologies. Any commonly accepted, secure identification technology could be integrated, such as, for example, RFID, magnetic strip, smartcard, infrared, biometrics, barcode, etc. The reader could include any or all of a display screen, audio capability, a logo light, a pin pad, and technology that could read the technologies referenced above.

Although the Application Controller referred to in the above description is described as a separate piece of hardware and/or software that interfaces with the site controller, the present invention is not so limited. For example, in certain exemplary embodiments, the Application Controller could be a software module that operated within the site controller itself. Additionally, the readers can be connected to the Application Controller either by wiring them together, via a wireless connection, etc. The wireless connection could be any standard wireless technology, such as Bluetooth, 802.11, etc. Also, the communication network used to process transactions can be any generally accepted, secure network technology such as, for example, satellite, dialup, frame relay, leased line, cable, ISDN, DSL, WiFi, etc.

The self-serve system may retain information within the Application Controller for the necessary time period to update necessary operational and marketing databases, such as, for example, inventory systems. Such systems may be updated in real-time, in batch mode, at predetermined time intervals, at particular triggering events, etc. Such interfaces could facilitate new applications, particularly in the case of real-time updates. For example, instant rewards or media could be delivered from operational and/or marketing databases directly to the readers, or to personal devices being carried by consumers such as cell phones, PDAs, MP3 players, and the like. Such rewards could be based on current or past behavior in the store. Additionally, inventory systems could be updated real-time to assist in better optimizing supply chain costs, improving sales performance, reducing stock outages, better understanding consumer behavior, improving negotiating leverage with vendors, etc.

2.4 Overview of Systems and Methods for Self-Serve Purchases in Accordance with the Above Example

Referring again to FIG. 1, it will be appreciated that the store 100 may include a store controller 114 and a checkout area. The checkout area in FIG. 1 includes pay point 1 118a and pay point 2 118b. The store controller 114 and the pay points 118a-b, along with the payment network 116 are typical of existing stores. The remaining elements, shaded in a light grey, may be thought of as being specific to the self-serve purchase system. The evenly dashed lines show customer movement; the solid lines indicate data flows related to the automatic coffee cup dispenser 102; the dotted lines indicate data flows related to the automatic fountain cup dispenser 104, the kiosk 106, and the vending machine 108; and the alternating dash-dot lines indicate data flows related to the receipt printer 110.

The customer enters the store and proceeds to the automatic coffee cup dispenser 102. The customer presents identification and, after system authorization, takes a cup for coffee and then pours coffee into the cup. At this point, the automatic coffee cup dispenser 102 sends data to the application controller 112 in response to the transaction. That data is passed to the store controller 114 and ultimately processed by the payment network 116. This transaction may be processed immediately upon indication of the customer, after a predetermined time interval before another transaction is made (e.g., while the customer is browsing), etc.

The customer next proceeds to the automatic fountain cup dispenser 104. the customer again presents identification and, after system authorization, takes a cup for a soda and then takes soda. Because the customer moves to the kiosk 106 before a triggering event and/or has not finalized all transactions, for example, data is sent to the application controller 112 but it is not sent to the store controller 114 for final payment. The customer next moves to the kiosk 106. Again, the customer presents identification and after system authorization orders a sub. Data again is sent to the application controller 112 but is not sent to the store controller 114 for finalization. The customer moves to the vending machine 108, presents identification, and makes a selection after system authorization.

After this step, the customer either may pass by the receipt printer 110 or simply exit. In the former case, printing a receipt will retrieve information about all transactions and tell the store controller 114 to finalize all transactions. In the latter case, after a predetermined timeout period, the application controller 112 automatically will instruct the store controller 114 to finalize all transactions. In either case, the transactions may be aggregated and sent via the store controller 114 to the payment network 116 to be processed as a single, aggregated transaction.

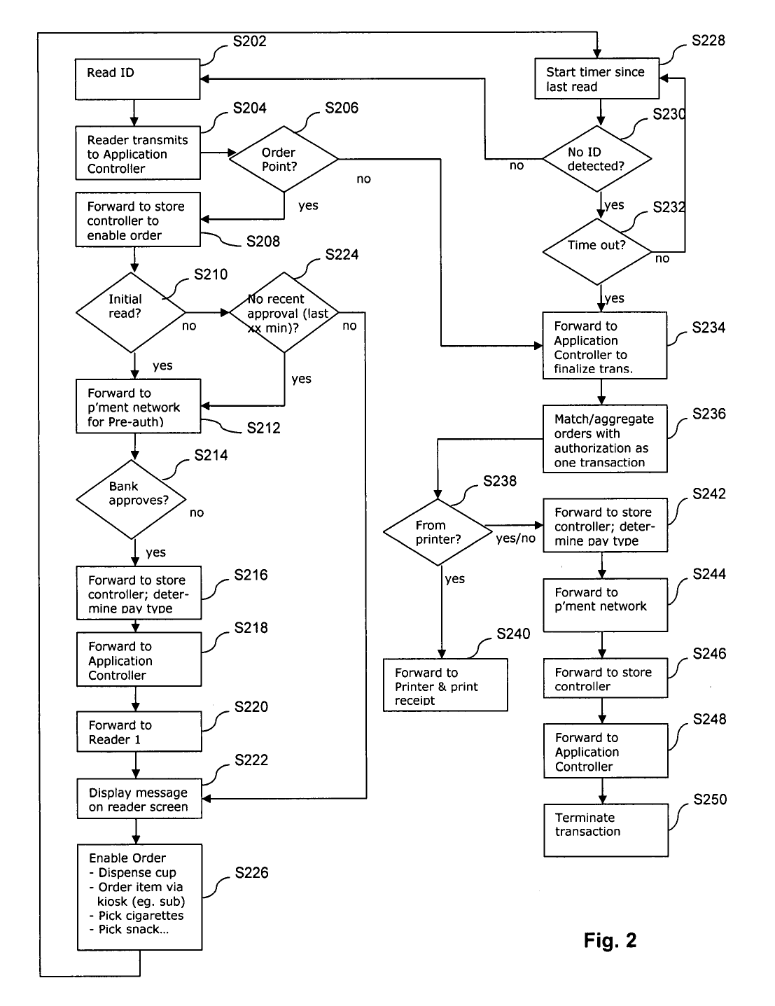

FIG. 2 is a flowchart demonstrating an illustrative process for using a self-serve purchase system in accordance with an exemplary embodiment. An id is read in step S202. the reader transmits identification information to the application controller in step S204. If it is determined that the customer is at an order point in step S206, the information is forwarded to the store controller to enable the order. If this is determined to be something other than the initial read in step S210, then a message is displayed on the reader screen at step S222. otherwise, the information is forwarded to the payment network for preauthorization in step S212. If the bank approves of the transaction in step S214, then the response is forwarded to the store controller and the pay type is determined in step S216. This information is forwarded back to the application controller in step S218 and then back to the reader in step S220. A message (e.g., indicating approval, with instructions, etc.) may be displayed on the reader screen in step S222. The order is enabled in step S226 (e.g., a cup is dispensed, an item is ordered via a kiosk, cigarettes are picked and dispensed, a snack or candy may be picked and dispensed, etc.).

A timer then will be initialized or reset in step S228. If there is an identification detected in step S230, the process returns to step S202 and proceeds as above. If there is a timeout detected in step S232, transaction information is forwarded to the application controller to finalize the transaction in step S234. Orders may be matched and/or aggregated to be processed as a single transaction in step S236. If the request is from a printer as determined in step S238, the total transaction information is forwarded to the printer and a receipt is printed in step S240. Regardless, total transaction information is forwarded to the store controller and the pay type is determined in step S242. This information is forwarded to the payment network in step S244. Information may be forwarded back to the store controller in step S246, e.g., indicating completion. This completion information may be forwarded to the application controller in step S248, which may ultimately terminate and/or finalize the transaction in step S250.
3. Simplified Systems, Methods, and Apparatuses for Enabling Self-Serve Purchases

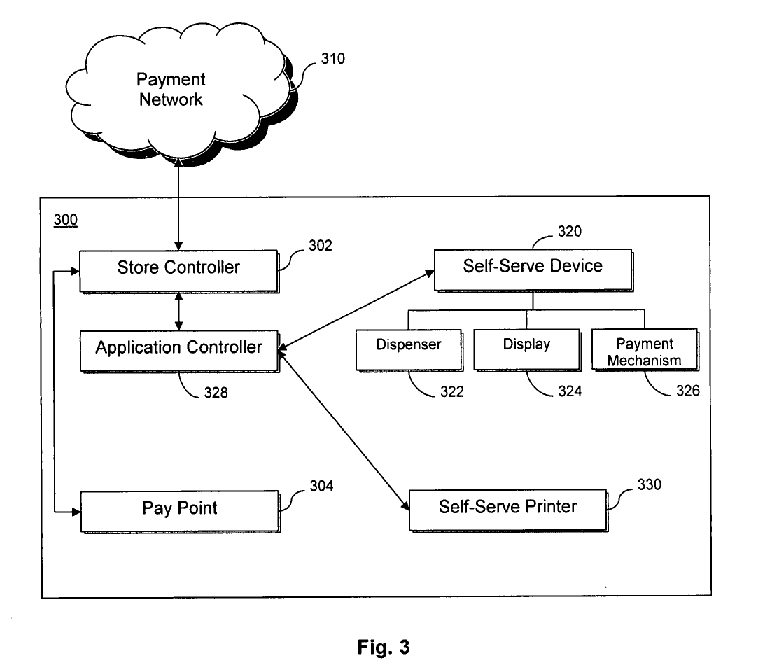

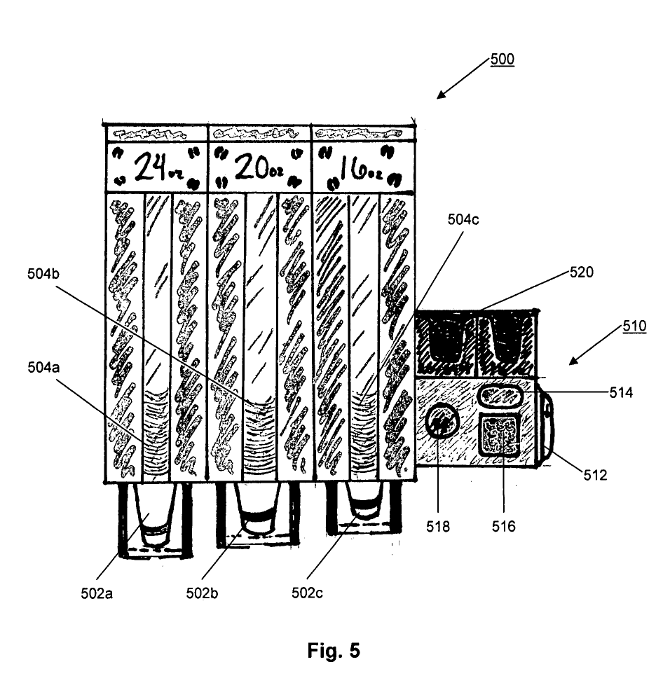

FIG. 3 is a simplified illustrative store layout including a self-serve purchase system in accordance with an exemplary embodiment. In FIG. 3, various components of a system for executing self-serve purchases are shown within a store 300. For example, the store 300, like many typical stores, may include a store controller 302 and at least one pay point 304. The store controller 302 may be configured to receive transaction information (e.g., items purchased, price, payment method, etc.) from the at least one pay point 304. In turn, the store controller 302 may share this information with a payment network 310 (e.g., when a credit or debit card purchase is made). At least one self-serve device 320 (e.g., of the type shown in FIG. 5 and described in greater detail below) may be provided. In brief, the at least one self-serve device 320 may be provided with a dispenser 322 (e.g., a cup dispenser), a display 324 (e.g., a small display indicating whether a payment is approved or disapproved, whether there is an error, etc.), and a payment mechanism 326 (e.g., for receiving an RFID payment device, credit card, cash, etc.). The at least one self-serve device 320 may communicate information about a self-serve purchase made at the machine to an application controller 328, which may be integrated into the store controller 302 or may exist separately. Finally, a self-server printer 330 in connection with the application controller 328 may be provided, for example, to allow a customer to print out a self-serve receipt indicating at least the self-serve transactions.

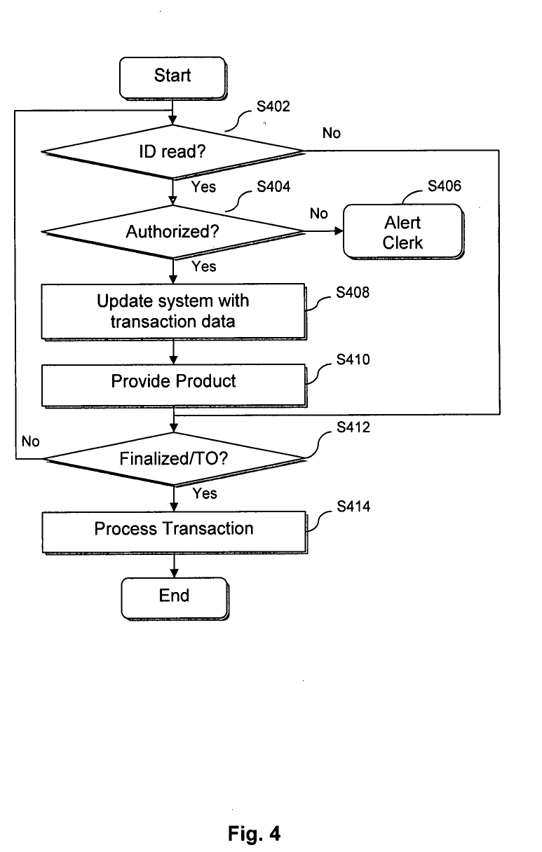

FIG. 4 is a simplified flowchart demonstrating an illustrative process using a self-serve purchase system in accordance with an exemplary embodiment. If an identification or other payment device is read in step S402, the system will determine if the customer is authorized to proceed with the self-service purchase. If there is no authorization granted in step S404, a store clerk may be alerted in step S406 and/or all transactions may be temporarily halted for at least this customer. If, however, the customer is authorized in step S404, the system is updated with transaction data in step S408 and the product is provided in step S410. If all purchases are completed or there is a time out (e.g., more than a predetermined period of time has elapsed since a last transaction) as determined in step S412, the transaction is finalized and processed in step S414. If however, not all purchases are completed and/or there has not been a time out, the process returns to step S402, awaiting for any potential additional orders. Of course, when the system in step S402 does not detect an identification or payment device being read, the system may jump to step S412 to determine if there are one or more orders that should be finalized.

FIG. 5 is an illustrative self-serve device 500 in accordance with an exemplary embodiment. Cups 502a-c of different sizes may be available to customers for self-serve purchase. The self-serve device 500 may include corresponding stacks of cups 504a-c as inventory. The self-serve device 500 also may include a purchasing mechanism 510, which may include a reader 512 (e.g., for reading an RFID, credit or debit card, etc.), a display 514 for outputting information to the customer, a keypad 516 (e.g., where the customer may input pin numbers, authorization information, respond to choices such as the number of cups, etc.), and a two-way communications device 518 for communicating with, for example, the store clerk. Also, coffee 520 or another product may be made available directly on or proximate to the self-serve device 500.

4. Illustrative Aspects and/or Features of Certain Exemplary Embodiments

Certain exemplary embodiments may incorporate one or more of the following illustrative aspects and/or features. It will be appreciated that these aspects may be used alone or in various combinations.
Integration of ID reader with a stand alone cup dispenser.
Self-service process for dispensing bulk beverages. Purchase and control is maintained by essentially paying when a customer receives the cup rather than paying when the customer receives the beverage.
Authorizing each time an item is selecting, but then aggregating all items as one payment transaction, helping to reduce, for example, the impact of fixed transaction fees.
Creating a self-serve process that does necessarily not involve manual scanning of items by the customer. By having a reader for each type of product to be purchased, the identification of the customer and the product are done simultaneously, simplifying the process for customers without sacrificing control of goods for the store.
Creating a self-serve process that does not necessarily involve manual scanning of items by the customer through the use of automatic detection of the item selected by the customer. This process enables sharing a reader for multiple products to be purchased and retains control by keeping track of which items are selected and how many items are selected.
Using a pre-authorization to allow removal of goods from a store prior to completion of the final transaction. This facilitates an entirely new class of service that does not necessarily require stopping at a control point to leave the store.
Use of wireless technology to connect multiple readers together as one virtual payment terminal, e.g., through the Application Controller.
Use of RFID for self-service beverage orders in a manner that does not require any change to beverage dispensing equipment. In other words, the fountain machine and/or the coffee pots do not necessarily need to be changed. The addition of a reader that is integrated into or linked to a cup dispenser, and the system that enables multiple ID readers for a single virtual terminal can be used without replacing beverage equipment.
A method whereby a self-service terminal is connected to a real-time payment system.
A method whereby the system can integrate RFID, smartcard, infrared, barcode, biometric, and/or magnetic strip identification technologies.
A method whereby identification and selection of an item are handled in one step by associating readers with each product.
Use of the consumer's mobile phone as a POS reader to communicate with the payment network and/or with the store controller.

It will be appreciated that programmed logic circuitry is intended to encompass any suitable combination of software, hardware, firmware, and/or the like. Additionally, any suitable computer-readable storage medium may be used in connection therewith.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A system for processing self-serve transactions of a customer, comprising:
a store controller capable of communication with a payment network;
at least one self-serve device for allowing the customer to order an item via the device, the at least one self-serve device comprising:
customer recognizing programmed logic circuitry to recognize the customer,
authorizing programmed logic circuitry to authorize, via the payment network, transactions on behalf of the customer after the customer is recognized, and
delivering programmed logic circuitry to cause an ordered item to be delivered to the customer after the customer is recognized by the customer recognizing programmed logic circuitry and after the authorizing programmed logic circuitry authorizes transactions for the customer; and, an application controller capable of mediating between the store controller and the at least one self-serve device.

2. The system of claim 1, wherein the at least one self-serve device further comprises a reader in cooperation with the customer recognizing programmed logic circuitry, the reader incorporating RFID, smartcard, infrared, barcode, biometric, and/or magnetic strip identification technologies.

3. The system of claim 1 wherein the authorizing programmed logic circuitry authorizes every transaction of the customer.

4. The system of claim 1, wherein the authorizing programmed logic circuitry performs an initial authorization for the customer and only authorizes transactions of the customer after a timeout period has been reached and/or after the customer indicates that all purchases have been completed.

5. The system of claim 1, wherein the application controller is capable of aggregate multiple transactions undertaken by the customer before instructing the store controller to process payment through the payment network.

6. The system of claim 1, further comprising a printer to print a receipt of all transactions of the customer.

7. The system of claim 6, wherein the printer is capable of instructing the application controller to finalize all purchases.

8. The system of claim 1, wherein the application controller is configure to finalize all purchases when a new purchase is not made within a predetermined time interval.

9. A method of processing self-serve transactions of a customer made using at least one self-serve device, the method comprising:
recognizing the customer via a reader;
authorizing, via a payment network, transactions on behalf of the customer after the customer is recognized;
delivering an item ordered by the customer after the customer is recognized and after transactions are authorized for the customer;
mediating between a store controller capable of communication with an outside payment network and the at least one self-serve device via an application controller.

10. The method of claim 9, wherein the reader incorporates RFID, smartcard, infrared, barcode, biometric, and/or magnetic strip identification technologies.

11. The method of claim 9, wherein the authorizing step is performed with every transaction of the customer.

12. The method of claim 9, further comprising re-authorizing the customer after a timeout period has been reached and/or after the customer indicates that all purchases have been completed.

13. The method of claim 9, further comprising aggregating multiple transactions undertaken by the customer before instructing the store controller to process payment through the payment network.

14. The method of claim 9, further comprising printing, via a printer, a receipt of all transactions of the customer.

15. The method of claim 14, further comprising finalizing all purchases when the receipt is printed.

16. The method of claim 9, further comprising finalizing all purchases when a new purchase is not made within a predetermined time interval.

17. A self-serve device for allowing a customer to order an item via the device, comprising:
customer recognizing programmed logic circuitry to recognize the customer;
authorizing programmed logic circuitry to authorize, via store controller in communication with a payment network, transactions on behalf of the customer after the customer is recognized; and
delivering programmed logic circuitry to cause an ordered item to be delivered to the customer after the customer is recognized by the customer recognizing programmed logic circuitry and after the authorizing programmed logic circuitry authorizes transactions for the customer.

18. The self-serve device of claim 17, further comprising a reader in cooperation with the customer recognizing programmed logic circuitry, the reader incorporating RFID, smartcard, infrared, barcode, biometric, and/or magnetic strip identification technologies.

19. The self-serve device of claim 17, wherein the ordered item is a beverage.

20. The self-serve device of claim 17, wherein the authorizing programmed logic circuitry performs an initial authorization for the customer and only authorizes transactions of the customer after a timeout period has been reached and/or after the customer indicates that all purchases have been completed.
